(19) United States
(12) Patent Application Publication
(10) Pub. No.: US 2023/0235178 A1
(43) Pub. Date: Jul. 27, 2023

(54) METHOD FOR INSERTING 2D FLAKES OF A TWO-DIMENSIONAL MATERIAL INTO PORES OF A POROUS SUBSTRATE

(71) Applicant: Grafren AB, Linköping (SE)

(72) Inventors: Erik Khranovskyy, Linköping (SE); Mykhailo Zhybak, Linköping (SE)

(21) Appl. No.: 18/011,615

(22) PCT Filed: Jun. 24, 2021
(86) PCT No.: PCT/EP2021/067374

§ 371 Date: Dec. 20, 2022

(30) Foreign Application Priority Data
Jun. 26, 2020 (SE) 2050776-0

(51) Int. Cl. C09C 1/46; B82Y 30/00

(52) U.S. Cl. CPC C09C 1/46; B82Y 30/00; C01P 2004/24; C01P 2004/22; C01B 2204/28

(57) ABSTRACT

A method for inserting 2D flakes of a two dimensional material into pores of a porous substrate comprises providing a porous substrate having a plurality of open pores, wherein at least some of the pores contain a gas, applying a liquid dispersion of flexible 2D flakes of a two dimensional material to the porous substrate; subjecting said porous substrate and said liquid dispersion to a vacuum, such that the gas is evacuated from the pores, causing the liquid dispersion to be introduced into the pores and removing the liquid from the pores, so as to leave the 2D flakes in the pores.

### TECHNICAL FIELD

The present disclosure relates to a method for encapsulation of two dimensional (2D) flake materials, in particular a nano-flake material, such as but not limited to graphene or graphene oxide, having a specific flake lateral size, inside porous substrates.

### BACKGROUND

2D materials are inorganic materials which have a crystalline nature but are only of a few nanometres thin, often single-atomic-layer thin crystals.

2D materials can be formed by a single element (e.g. graphene, graphene oxide, borophene, stanene, silicene, germanene etc) or complexed ones, including two (hexagonal-BN (hBN), transition metal carbides, nitrides, or carbonitrides (MXenes), MoO₃, WO₃, MoS₂, WS₂, MoSe₂, WSe₂ and other chalcogenides and dichalcogenides, layered oxides) or more elements (LaNb₂O₇, Ca₂Ta₂TiO₁₀, perovskite-type, hydroxides etc).

At present there are mainly two approaches for 2D materials production: i) bottom-up approach—where the 2D layer is grown or synthesized from the respective precursors or ii) top-down approach—where the bulk crystals are exfoliated into a single atomic layers crystals—called flakes or 2 flake material.

2D materials possess a number of unique properties, due to their low dimension as well as high surface-area-to-volume ratio and the resulting effects. Most important, their mechanical properties are different from their bulk counterpart: due to their extremely low thickness, flakes of 2D materials can be easily bended, folded, jammed or anyhow else changed in their shape and lateral size under mechanical forces. Bending or folding does not destroy the 2D materials or affect their integrity. Furthermore, after being deformed, 2D flakes release the strain and extend again into their original size.

The discovery of 2D materials brings new possibilities to the field of vacuum impregnation due to the above-mentioned material properties. Thus, the flakes of 2D materials are providing an exciting media for being impregnated, along with their record large surface area, where most of the functional groups of each 2D flake are active.

Surface modification of the porous substrates with any 2D flake materials, raises several problems: how to attach the 2D flakes to the surface, how to insert these flakes into the pore, and thus into the volume of porous substrate, and let them stay there confidently, and how automate such a process.

In various applications, pressure impregnation is used on different surfaces, to smoothen or seal them.

In contrast to the here used pressure impregnation method, in the vacuum filtration, the aim is not to insert the particles into the filter, but instead to separate out particles of different size using the filter utilizing vacuum. Therefore, the two techniques cannot be considered equivalent. The process further doesn't solve the problem of how insert said 2D flakes deep into a porous substrate nor does it describe how to attach the particles without additives. 2D materials have great surface area. Few techniques allow them to stay together and not collapse. Hence, there is a need for a robust structure with a high active surface area.

### SUMMARY

It is an object of the present disclosure, to provide a method for inserting 2D flakes of a 2D material into pores of a porous substrate.

The invention is defined by the appended independent claims. Embodiments are set forth in the appended dependent claims and in the following description and drawings.

According to a first aspect, there is provided a method for inserting 2D flakes of a two-dimensional material into pores of a porous substrate, comprising providing a porous substrate having a plurality of open pores, wherein at least some of the pores contain a gas, applying a liquid dispersion of flexible 2D flakes of a two-dimensional material to the porous substrate, subjecting said porous substrate and said liquid dispersion to a vacuum, such that the gas is evacuated from the pores, causing the liquid dispersion to be introduced into the pores, and removing the liquid from the pores, so as to leave the 2D flakes in the pores.

Applying the liquid dispersion may comprise at least partially immersing the porous substrate in the liquid dispersion.

The method may further comprise enclosing the porous substrate and the liquid dispersion in a pressure chamber, and providing the vacuum by extraction of gas from the pressure chamber.

The method may further comprise injecting a gas into the pressure chamber, so as to raise a pressure in the pressure chamber.

The method may further comprise draining any excess liquid dispersion and/or carrier liquid from the pressure chamber.

In the method, removing the liquid may comprise subjecting the porous substrate to an elevated temperature, and/or to a reduced pressure.

The elevated temperature and the reduced pressure may be selected so as to enhance evaporation of the liquid.

In the method, the 2D flake material may comprise at least one material selected from a group consisting of G, GO, CrPS₄, CrGeTe₃, CrSiTe₃, MnPSe₃, ReSe₂, Ta₂NiS₅, Ta₂NiSe₅, Bi₂Se₃, BN, ReS₂, FeSe, GaSe, hMoS₂, MoSe₂, WS₂, WSe₂, CdPS₃, HfS₂, HfSe₂, InSe, PtSe₂, TiS₃, PtS₂, SnS₂, TaSe₂, TiS₂, ZrS₂, ZrSe₂, MoTe₂, NiS₂, NiSe₂, WTe₂, Bi₂Te₃, GaTe, MnPS₃, BiI₃, V₂O₅, PdSe₂, ZnPS₃, MoO₃, HfTe₃, RuCl₃, SnO, P, SnSe, NiPS₃, C₃N₄, FePS₃ Ca₂N, WO₃, MoS₂, Ge, and Si.

The porous substrate may comprise at least one material selected from a group of materials which pores are formed:

i) as an inherent feature of particular crystalline structures (e.g. zeolites and some clay minerals);

ii) by aggregation and subsequent agglomeration of small particles (e.g. inorganic gels and in ceramics);

iii) as a feature of complex structures (e.g. as polymer fibers, textile, nonwoven, knitted textiles, or the like);

iv) using subtractive approach (e.g. porous metal oxides, porous glasses); or

v) such that the pore structure is determined by natural processes of cell division and self organization (e.g. plant and animal tissues).

The 2D flakes may comprise graphene oxide.

The 2D flakes may present an average thickness of 0.3-1 nm or 1-100 nm, preferably 1-5 nm or 1-10 nm.

The 2D flake material may be present in the dispersion in an amount corresponding to 0.01-40 g/dm3, preferably 0.01-0.1 g/dm3, 0.1-1 g/dm3, 1-10 g/dm3 or 10-40 g/dm3.

The reduced pressure may be reduced to pressure below the initial pressure, the pressure being of a range between 200 mBar and 0.01 mbar, preferably 100 mbar and 0.1 mbar, and the initial pressure of the at least one orifice covered by the liquid dispersion, designated in-pressure is higher than 200 mBar and the difference between in-pressure and reduced pressure is at least 800 mBar.

In the method, orifices of the pores may present an average cross-sectional area which is 20% to 80% of an average maximum cross-sectional area of the pores.

In the method, an average cross-sectional area of the pores may be 40% to 80% of an average surface area of the 2D flakes.

The 2D flakes may present an average flake size of 0.1-0.5 μm2 or 0.5-100 μm2, and preferably 95% of the 2D flakes may have flake sizes which differ less than 20% from said average flake size.

According to a second aspect, there is provided a porous composite material, comprising a porous substrate comprising a solid material enclosing a plurality of open pores, a plurality of flexible 2D flakes of a 2D material distributed within the porous substrate, wherein at least some of the pores have an opening providing a restricted flow path into the respective pore, and wherein the size of the 2D flakes cause them to be retained in the pores by the openings.

According to a third aspect, there is provided a composite material, comprising a substrate in the form of a textile, composed of a plurality of interlaced, and optionally bonded, fibers and/or threads, wherein the fibers or threads are individually coated by flexible 2D material flakes.

The present inventors have discovered that when using a porous substrate in the form of a textile, in the method described above, the threads or fibers from which the textile is formed become coated by the 2D material flakes wherever the a fiber or thread surface is exposed to the 2D material flakes.

The fibers or threads being “individually coated” means that the 2D material flakes cover the surface of each fiber or thread, such that the fibers or threads provide a thin coating on the surface of the fiber or thread.

The flakes may cover at least 80% of each fiber surface of thread surface, preferably at least 90%, at least 95% or at least 90%.

The textile may be selected from a group consisting of a woven textile, a nonwoven textile, a braided textile and a knitted textile.

The flexible 2D material may be an electrically conducting material, such as graphene or graphene oxide.

### BRIEF DESCRIPTION OF THE DRAWINGS

FIGS. 1a-1d show schematic views of a vacuum impregnation assembly.

FIG. 2 is a schematic illustration showing a porous substrate and different categories of pores.

FIGS. 3a-3d schematically illustrate various types of fabrics.

FIG. 4 is a schematic illustration showing a cross-section of a porous substrate prior to vacuum treatment.

FIG. 5 is a schematic illustration showing a cross-section of a porous substrate immerged into a liquid dispersion.

FIG. 6 is a schematic illustration showing a cross-section of a porous substrate at a later stage of vacuum treatment, 2D flakes are deformed an replace the gas in the pores.

FIG. 7 is a schematic illustration showing a cross-section of a porous substrate at a later stage of vacuum treatment, deformed 2D flakes have moved deep into the substrate replacing the gas.

FIG. 8 is a schematic illustration showing a cross-section of a porous substrate at a final stage of vacuum treatment, substantially all gas is replaced with liquid dispersion.

FIG. 9 is a schematic illustration showing a cross-section of a porous substrate after resetting pressure, 2D flakes are attached in the pores due to their shape.

FIG. 10 is an image showing a cross section of a composite material deeply penetrated with 2D flakes.

FIGS. 11a-11b schematically illustrate process step 1: Perspective and side view of a porous substrate being placed into a liquid dispersion within a vacuum chamber.

### DETAILED DESCRIPTION

The present invention relates to complex composite material, based on a porous substrate impregnated with 2D flakes and a method of preparing such a composite material thereof. The method for preparing said composite material is simple, low-cost, and applicable in high-volume industrial production.

When 2D materials are mentioned in this document, it is referring to a group of material namely a family of 2D materials. These are inorganic materials which have a crystalline structure but are only of a few nanometers in thickness, often single-atomic-layer thin crystals. 2D flake material or just 2D flakes, refer to 2D material substantially only comprising particles of single to a few atomic layers, giving them certain common properties. Common 2D material may include G, GO, CrPS₄, CrGeTe₃, CrSiTe₃, MnPSe₃, ReSe₂, Ta₂NiS₅, Ta₂NiSe₅, Bi₂Se₃, BN, ReS₂, FeSe, GaSe, hMoS₂, MoSe₂, WS₂, WSe₂, CdPS₃, HfS₂, HfSe₂, InSe, PtSe₂, TiS₃, PtS₂, SnS₂, TaSe₂, TiS₂, ZrS₂, ZrSe₂, MoTe₂, NiS₂, NiSe₂, WTe₂, Bi₂Te₃, GaTe, MnPS₃, BiI₃, V₂O₅, PdSe₂, ZnPS₃, MoO₃, HfTe₃, RuCl₃, SnO, P, SnSe, NiPS₃, C₃N₄, FePS₃ Ca₂N, WO₃, MoS₂, Ge, and Si. 2D materials may be formed by a single element (e.g. graphene, graphene oxide, borophene, stanene, silicene, germanene etc) or more complex compounds ones, including two (hBN, MXenes, MoO₃, WO₃, MoS₂, WS₂, MoSe₂, WSe₂ and other chalcogenides and dichalcogenides, layered oxides) or more elements (LaNb₂O₇, Ca₂Ta₂TiO₁₀, perovskite-type, hydroxides etc).

Various 2D materials exist. These different materials possess different properties like antibacterial, adsorbent etc., making the prepared composite material suitable for different applications. Furthermore, if the material of a 2D flakes has suitable properties, like being foldable and being of suitable size, said 2D flake-material will be suitable for the hereby described method. Consequently, the following description applies to all combinations of porous substrates and 2D materials suitable for the end use of the created composite material and having suitable properties for one or more the techniques hereby described.

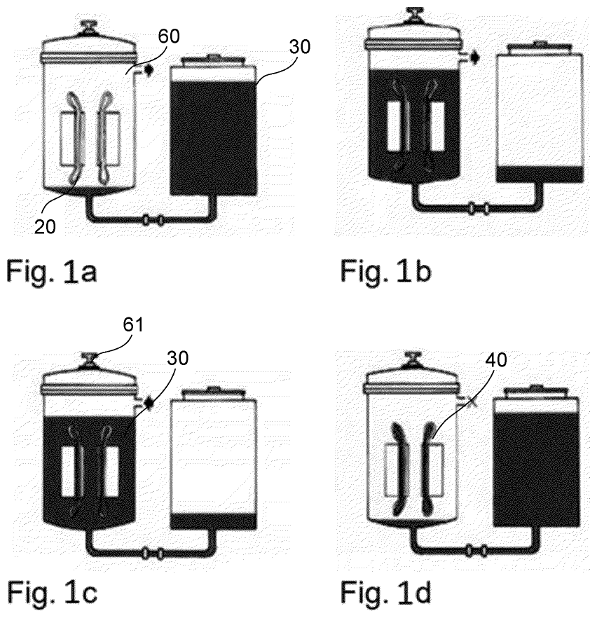

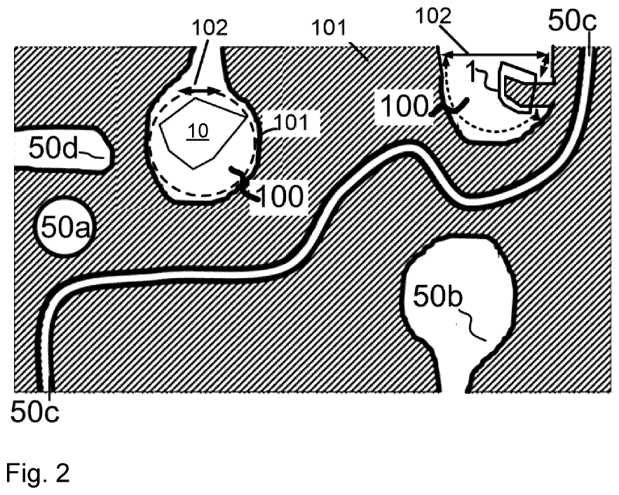

FIG. 1a schematically illustrates a porous substrate 20 placed in a pressure chamber 60. At this point, gas evacuation is started such that pressure decreases.

FIG. 1b schematically illustrates a liquid dispersion 30 with 2D foldable flakes being introduced into the pressure chamber 60 with porous substrate 20 and under decreased pressure conditions.

FIG. 1c schematically illustrates the foldable flakes being inserted into the porous substrate. At this point a valve 61 is opened and pressure in the chamber increases.

FIG. 1d schematically illustrates the liquid dispersion being pumped out of the pressure chamber 60, whereby pressure is equilibrated and composite material 40 has been formed.

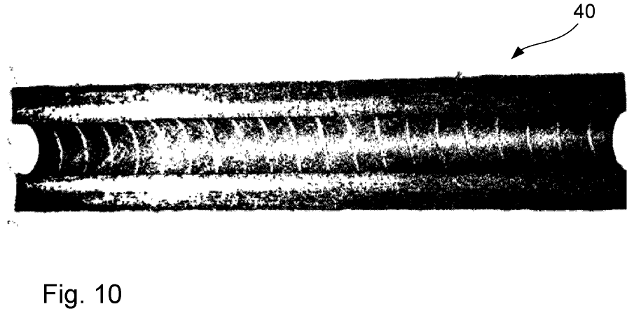

Graphene oxide (GO) is the 2D materials most thoroughly tested and it has many interesting properties suitable for both various uses (like filtering) as well as it is suitable for described processes, being foldable during pressure treatment. The term 2D flakes refers to flakes of a 2D material, which may be present in a liquid dispersion 30. The liquid dispersion advantageously having flakes with a controlled surface area (lateral size), having an average lateral size with statically distribution of low variance, such that the flakes can be supplied to the porous substrate with suitable lateral sizes for said substrate. The term foldable refers to the property of a 2D flake to fold/reform and thus reshape, when being subjected to physical force. For the purpose of understanding: the term porous substrate 20 substantially refers to a solid volume of more or less hollow texture, thus comprising cavities/pores 50 that can be filled with gas/liquid or smaller solids (ex 2D flakes). When the porous substrate 20 is impregnated with 2D flakes, the combination is referred to as complex composite material 40 (FIG. 10).

2D materials, due to their distinctive features to gain and release the mechanical stress, 2D flakes are interesting for vacuum impregnation technology. Thus, they can be compactly folded, then transported deep into a pore, and being released to their original size afterwards, staying inside of the pore 50 of a porous substrate 20. The above described is valid if several conditions are fulfilled:

1. The flakes of 2D material are dispersed in liquid solution based on water or any organic solution and chemically neutral to the material of porous structure.

2. The lateral size of the flake f and pore size d are matching and lays within specific ratio—f/d=1 to 2. For the flakes with f/d ratio less than 1 the flakes will be freely transported back and forth through the pore, without being contained. For the f/d ratio more then 2, the possibility for flake to cover two and more pores increase, thus the transportation into the pore is compensated.

3. The porous structure is hollow, enabling flow of liquid through it, and has diverse space on the way of flakes to be transported and kept.

Thus, the complex porous structures can be obtained; containing composite material 40 (FIG. 10)—initially hollow porous media and filler—impregnated 2D flakes 10 with large active surface area. Such an approach enables incontaining/locking of 2D flakes 10 having their surface active and open for interaction. Such a complex porous structure can be used in the processes where the efficient interaction with any kind of fluids with 2D materials with high surface, locked in a small volume. For example, as fabrics, filters, sorbents, catalysts, inhibitors etc. for wide range of liquids or gases. Conventional methods involving vacuum filtration, and vacuum impregnation (see FIG. 2), have several key differences and shortcomings compared to this technique.

Thus, the described method allows obtaining of a resulting complex 3D material, hereby designated composite material 40, comprising 2D flakes with high surface area for filtration, chemical treatment, catalytic reactions or any other interaction-based processes.

Not all 2D materials are stable in ambient conditions or in water-based solutions.

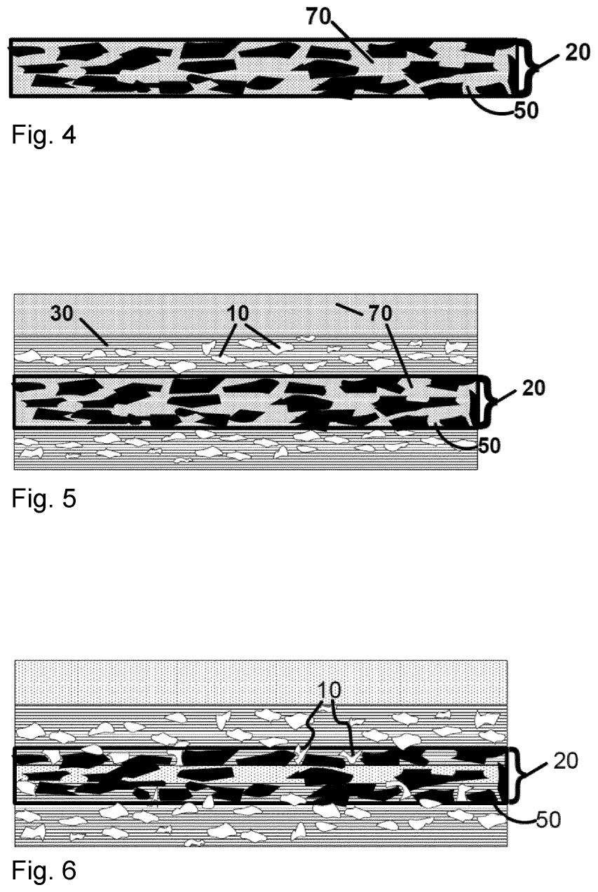

The method will now be described with reference to FIGS. 4-9.

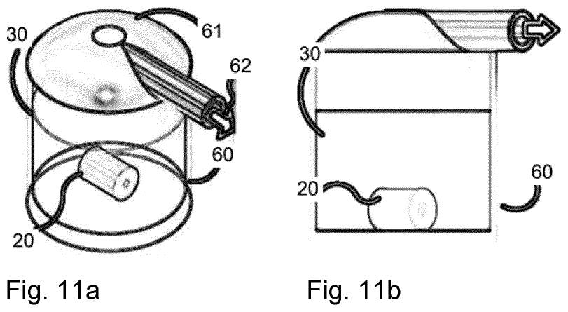

Referring to FIGS. 4-5, the method is performed by placing a porous substrate 20, possibly permeable material, into a liquid dispersion 30 of foldable 2D flakes 10 of suitable lateral sizes. This is preferably performed within a sealable gas/liquid container, such as a pressure chamber 60 (FIGS. 11a-11b). Due to surface tension, the substrate will initially comprise gas attached within the porous substrate cavities/pores 50. By after this, vacuum treating the substrate (FIG. 6), in the sense of removing gas from within the substrate, possibly within a pressure chamber 60, the gas within the substrate pores 50 will be replaced by liquid and 2D flakes, partially by flakes of larger lateral size than the pores cross-section-area normally would allow. Since many 2D flakes 10 are highly foldable, they can deform by the pressure differences occurring during the vacuum treatment, and thereby reduce their lateral range, whereby they can move deeper into the substrate pores 50. Furthermore, while being subjected to said pressure differences, the 2D flakes 10 sometimes adjust shapes according to the nearby structure of the pores, and thereby sometimes physically attaching the 2D flakes 10 in a position due to their similar structure to the nearby environment. This technique therefore solves two problems, how to get 2D flakes 10 deep into a porous substrate 20 as well as how to attach them within the substrate.

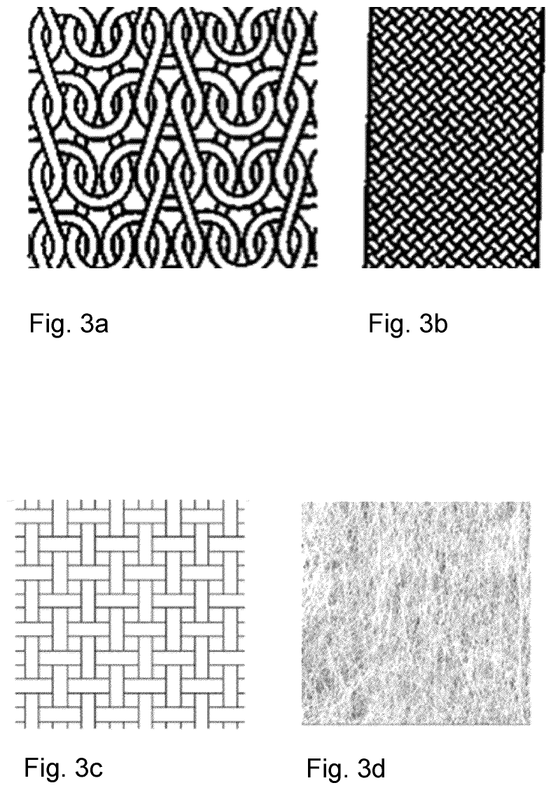

A common definition of porous substrates 20 are volumes with pores 50, i.e. cavities, channels or interstices, which are deeper than they are wide. Porous substrate is comprising pores of different types: closed (totally isolated from their neighbors and unavailable to an external fluid) and open pores (which have a continuous channel of communication with the external surface of the body). Open pores of the substrate can be blind (open only at one end) and/or through (open at two ends). The shape of substrates' pores may be cylindrical (either open or blind), ink-bottle shaped, funnel shaped or slit-shaped. Open pores are the ones of interest, the following types are described in combination with FIG. 3: cylindrical (open 50c and blind 50d), ink-bottle shaped 50b and closed 50a. Porous substrates mainly come in three types: microporous (pores widths<2 nm), mesoporous (pores widths 2-50 nm) and macroporous (pores widths>50 nm). Due to the use of the 2D flakes, mainly mesoporous and macroporous are relevant to this application.

Another type of porous substrate, which is considered in this application, are fibres based materials: textiles, fabrics, non/woven or weaved, knitted etc. In this case the pore is defined as a space in the volume of the substrate, limited by fibers.

By way of example, FIG. 3a schematically illustrates a knitted fabric.

FIG. 3b schematically illustrates a braided fabric.

FIG. 3c schematically illustrates a woven fabric.

FIG. 3d schematically illustrates a non-woven fabric.

It is understood that the threads or fibers making up the fabric may together form pores.

Porous materials, are of significant interest in many areas due to their wide range of applications, ranging from filtration membranes, and catalyst supports to biomaterials such as scaffolds for bone ingrowth or drug delivery system. Porous systems are also used as piezoelectric materials, as thermally or acoustically insulating bulk materials or coating layers, reinforcement components for composite materials and electrically active materials. Constraints vary according to the different cases. Whatever the application, there is an obligation to find a compromise between porosity and sufficient mechanical strength.

In terms of porous substrate, diverse materials can be used, depending on the desired application.

In particular, using polypropylene fabric with porosity of 1-25 μm as a porous substrate and graphene/graphene oxide as impregnating material it is possible to produce complex porous materials. Such materials comprise the flakes of 2D materials subjected to the environment, with its high surface area and simultaneously provide hard and compact framing structure, holding the flakes together. This is an important issue, since many 2D materials has active surface area, but are not able to maintain porous structure and just collapse and agglomerate.

Example of application of such complex porous materials are sorbents for extraction of inorganic species, of cationic nature, like metals ions and/or organic compounds, diverse positively charged polymeric residues or dyes, or the like. Thus, the potential application of the sorbents based on porous complex materials can be water treatment and purification, particularly industrial waste or process water. Alternatively, the sorbents can be used as parts of filtering and water purification system for potable water in the vulnerable areas.

It is crucial, that the sorbent can be used not only in liquids, but also in aerosols, which extends their applications area. Thus, the sorbent can remove target contaminants from aerosols, available in the air due to moisture. Thus, the complex porous complex materials can be used for biological, chemical or mechanical purification of the air to be inhaled or any other gases with target contaminants.

One specific advantage, which complex porous materials can provide, is that in case of impregnation of the flakes of highly conductive materials (graphene etc) into the substrate with high porosity—which allows interconnections of the impregnated flakes—it is possible to obtain electrically conductive materials. Such materials would possess so called volumental conductivity, be robust for mechanical stress, deformation or even partial damage. The potential application of such materials can be parts or components of the smart textile or e-wearables: in this case the textile fibres could serve as a porous substrate for impregnation of the flakes of 2D materials. Particular applications include electrodes for powering, or for signal transmission, in the area of smart textiles and wearables. Such materials by themselves may serve as an active components—like sensors and detectors of external influence on the fabric. Due to electrical property of individual fibers, any external impact will affect the resistivity of the respective area of the fabric. Based on electrically conductive fabric comprising fibers coated by graphene and other 2D materials may be constructed impact, damage, pressure or strain/elongation sensors. Such sensors may be used as a components for smart textiles and devices for gesture recognitions and positioning for providing a feedback in human/machine interaction.

Another application of the complex porous structures can be the processes for catalysis or inhibition in the industry or in specific application areas. Finally, these structures can be used in such applications as ion exchange membranes for fuel cells or for the preparation of the gas analyte in sensing technologies etc.

By utilizing the above-mentioned technique, one can create a complex composite material 40 comprising the benefits of 2D material without the need of chemical treatment, harsh solvents usage or the like. The method has successfully been tested on several porous substrates 20, having different pore sizes, different thickness and of different material.

Furthermore, by resetting the pressure surrounding the prepared composite material 40, thereby removing said pressure differences, the 2D flakes 10 tend to reform, thus restoring their original lateral size. This may cause them to get enclosed in their position due to their reformed lateral size being larger than any exit from the nearby environment.

The composite material 40, developed by the substrate modified with 2D flakes 10, treated with the method above, have shown to have 2D flakes, in particular of GO-material, deep into the substrate wherein some are physically attached in positions due to they're similar structure to the nearby environment, and/or have some 2D flakes 10 that are enclosed in positions due to their reformed lateral size being larger than any exit from the nearby environment. The 2D flake modified composite material thereby have 2D flakes 10 that, during normal usage when not being subjected to said pressure differences, stays attached within the composite material 40, without the need of additives, adherents and specific properties, making them favorable to similar products of prior art, in certain circumstances.

Regular vacuum impregnation is mainly used for sealing pores and gaps with the particles of smaller or matched size with pores. In this process the aim and result is to fill, without sealing, the pores. As with regular vacuum impregnation, the impregnating material that here corresponds to the 2D flakes, tend to shape according to the adjacent solid surface and thereby also tend to attach to said surface. However, here said surface corresponds to the internal walls of the substrate. The combined properties of used process, substrates and 2D flakes, can be set as to allow the 2D flakes to penetrate deep into the porous substrate and attach without sealing the pores. Possibly the described process could be defined as an impregnation of the internal cavities of a porous solid volume, which would then correspond to a special case of vacuum impregnation. Furthermore, another crucial addition to what could be defined as a regular vacuum impregnation, is the use of 2D material in the process, in particular graphene oxide material, since they have very suitable properties for achieving the described result. More details:

During normal circumstances, using the developed composite material 40, without vacuum nor pressurizing the composite material, the 2D flakes 10 will not be deformed/folded and thus, it will cover a larger area, sometimes larger than the surrounding conduits. Therefore, they will not detach from the composite material and will be substantially adhered, without the need of added adherent. In prior art, this seems to be achieved using various adherent chemical solutions or the like. Conventional methods therefore add additional chemicals, hypothetically unhealthy, and provides extra process steps that make composite material 40 production more difficult.

A porous permeable substrate, is may have through pores 50, the possibility of randomly sized cross-section-areas. It is likely that the cross-section-areas vary in size, between pores as well as differ in size along the pores extent from a first orifice to a second. This can be beneficial, since a large flake that is folded/deformed during vacuum treatment, and thereafter reforms back into larger size, within a larger section of the pore, having extensions of smaller size in all direction, will be enclosed within this large section, and is therefore prevented from moving. This randomly porous permeable material, thus has a natural ability to enclose/entrap the 2D flakes 10 within the pores 50 without need of glue or other adherent, using the hereby described technique.

The above described benefits can also be achieved with a more controlled pore creation. A base substrate can be created, comprising through pores 50 with a cross-section-area (CSA), having an average size with small variance. Some through pores have sections along their extensions being of larger CSA than the average CSA. A liquid dispersion 30 can be supplied comprising 2D flakes 10 of controlled surface area size (flake size), with an average flake size of low variance, the average flake size unfolded being slightly larger than what the average CSA would allow to pass through, but still small enough to pass through when folded/deformed. The hereby described technique in combination with the substrate base of controlled pore size and flakes of controlled size, thus enables the creation of composite materials 40 having 2D flakes 10 safely entrapped/attached within the substrates. It should also be noted that liquid dispersions of controlled flake size according to above, can advantageously be manufactured using another patent by the same inventor.

Furthermore, this method also solves the problem of how to get the flakes further into the substrate. Common pressure impregnation techniques usually cover the surface of a solid. They usually intend to seal porous surfaces, often with resin not comprising freely floating solids. When treating substrate with specific material, it is obviously often advantageous if the material is present throughout the entire inner volume of the substrate. This should preferably be done without added chemicals or materials that might come loose. This method, when removing the innermost gas of the pores 50, either forces the liquid with 2D flakes 10 from the dispersion 30 to replace the innermost gas. The method described here can therefore easily create novel complex porous materials with improved properties regarding the above.

Another advantage of the hereby described technique is that the material of said base substrate is less relevant. When using any type of glue or adherent, it is of paramount importance that said material is attachable and usable together with the glue and 2D flakes 10, possibly GO-flakes. Since the adherent properties here are physically induced, due to the flakes getting enclosed within the porous substrate 20, the manufacturer can instead focus on other properties of the base substrate, like sustainability, hardness, environment friendliness etc. Furthermore, one more adherent substance entails, one more substance that might be: sensitive to wear, non-water/acid/base-resistant, non-modifiable, pollute etc.

Referring to FIGS. 4-5, the method is performed by placing a porous substrate 20 (FIG. 4), possibly permeable material, into a liquid dispersion 30 of foldable 2D flakes 10 of suitable lateral sizes (FIG. 5). This is preferably performed within a sealable gas/liquid container, such as a pressure chamber 60 (see FIGS. 11a-11b). Due to surface tension, the substrate will initially comprise gas attached within the porous substrate cavities/pores 50. By vacuum treating the substrate (FIGS. 6-8), in the sense of removing gas 70 from within the substrate, possibly within a pressure chamber 60, the gas within the substrate pores 50 will be replaced by liquid and 2D flakes, partially by flakes of larger lateral size than the pores cross-section-area normally would allow. Since many 2D flakes 10 are highly foldable, they can deform by the pressure differences occurring during the vacuum treatment, and thereby reduce their lateral range, whereby they can move deeper into the substrate pores 50. Furthermore, while being subjected to said pressure differences, the 2D flakes 10 sometimes adjust shapes according to the nearby structure of the pores, and thereby sometimes physically attaching the 2D flakes 10 in a position due to their similar structure to the nearby environment. This technique therefore solves two problems: how to get 2D flakes 10 deep into a porous substrate 20 and how to attach them within the substrate.

FIG. 9 shows that liquid dispersion is removed, gas returned back into the pores, however, flakes remained in the pores too, because of their size that is bigger than the orifice of the pore and they cannot leave the pore and are attached there.

Referring to FIGS. 11a-11b, there is disclosed a pressure chamber 60 having a lid 62 and an exhaust connector 62.

### Process

To further describe the invention and various embodiments it is described as a process comprising several steps, with reference to various drawings, in particular FIG. 4 through FIG. 9:

In a first preferred embodiment of the present invention, the method for creating the composite material 40, based on a porous substrate 20 (FIG. 4) impregnated with 2D flakes can comprise the following steps:

If not in other way provided, prepare a 2D flake dispersion 30, in particular a dispersion of graphene oxide (GO):

1. The 2D flakes 10 should preferably be foldable. Advantageously a graphene oxide liquid dispersion 30 could be according to the following: 10 mL of graphene oxide solution with concentration of 0.001-40 mg/mL to obtain graphene oxide liquid dispersion.

2. If the flakes aren't substantially single-layered, they should be prepared. Advantageously by ultra-sonic treating said liquid dispersion 30 for a sufficient amount of time, to make the flakes substantially single-layered.

3. Advantageously separate flakes of appropriate size, into a separate liquid dispersion 30.

Subject a substrate to the 2D flakes dispersion 30, the substrate possibly suitable as a polypropylene (please refer to ex FIG. 3 for visual guidance), the 2D flakes 10 possibly of GO.

4. Introduce (FIG. 5) said porous substrate 20 to a liquid dispersion 30 of 2D flakes, advantageously by immerging said porous substrate into a prepared liquid dispersion of 2D flakes, possibly of substantially single-layered graphene oxide flakes of appropriate size, possibly said liquid dispersion, prepared in step 0, and advantageously within a sealable pressure chamber 60.

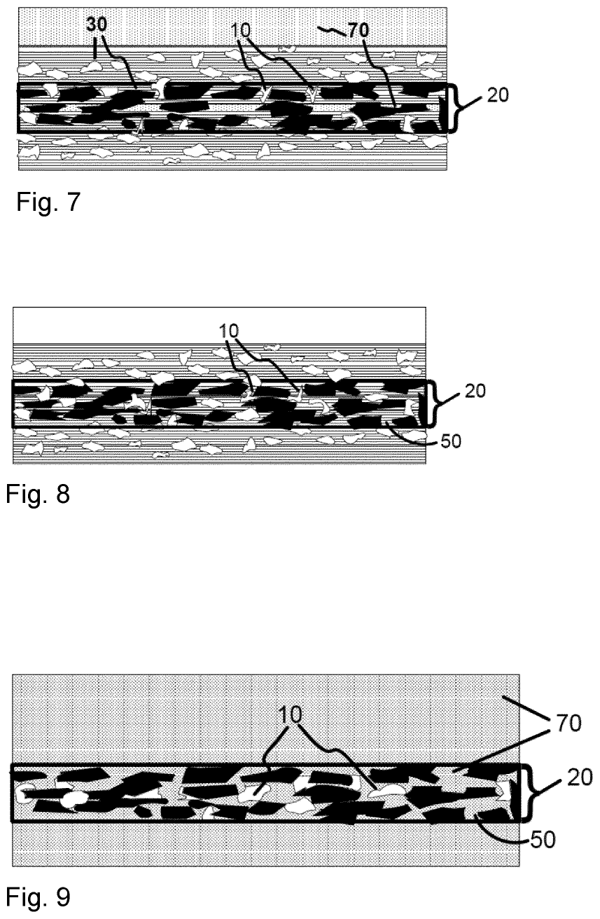

5. Vacuum treat the substrate (FIG. 6, 7), advantageously by Vacuum treating the content within said sealable pressure chamber 60, i.e. extract the gas from the container and the porous substrates cavities, such that only a gas amount normally considered as vacuum remains. Thereby the gas attached within the pores 50 is removed from the cavities. This gas will then be replaced by the content of the liquid dispersion, meaning the liquid and 2D flakes (see FIG. 6 to FIG. 7). During this vacuum treatment, the 2D flakes 10 are prone to deform, thus more easily fit in to and move into pores 50, that their lateral size normally wouldn't allow.

6. After the step 5, porous composite material 40 can be removed from the dispersion (FIG. 8) and dried at normal conditions until full evaporation of water from the dispersion impregnated inside the porous substrate (FIG. 9).

Several tests have been done and the pressure settings obviously depend on the initial pressure as well as the substrate material used etc, but a recommendation is that, the reduced pressure is reduced to pressure below the initial pressure, the pressure being of a range between 200 mBar and 0.01 mbar, preferably 100 mbar and 0.1 mbar, and the initial pressure of the at least one orifice covered by the liquid dispersion. It is also of importance that the average 2D flake size matches the pore size. If the 2D flakes are to large compared to the pore orifices, they are likely to just clog the pores whereby you achieve a porous substrate whit sealed pores, and 2D flakes not likely to attach. The settings depend on the context, but suitable settings can be, that the orifice of a pore on average have a cross-section area of 20% to 80% of the maximum cross-section of the pore, and on average 40% to 80 of the average flakes surface area size. In order for the flakes and the pores to match, it is obviously also good if the 2D flake size is predictable, therefore it suitable that the 2D flakes present an average flake size of 0.5-100 μm2, and wherein 95% of the 2D flakes have flake size which differs less than 20% from said average flake size.

Benefits of immersing the substrate: By totally immersing the substrate into the dispersion, all open pores of the substrate will be affected by the vacuum treatment.

Two dimensional flakes (2D flakes) of graphene oxide GO-flakes and many other 2D flakes 10 are highly foldable, due to their single to few layers structure, so when exposed to a high-pressure difference between different parts of a pore, created by extraction of gas within the pore, naturally replaced by the liquid, as in step 5 above, they are prone to fold/deform and follow the liquid into the pore. The flakes will then often fold to a smaller lateral size and even move into pores of smaller cross-section-area than the flake initially had. Nevertheless, some of the flakes seem to deform according to the shape of the pores cavities, making them mechanically attach within the pores, sort of like pieces of a jigsaw puzzle, (see ex FIG. 2 or FIG. 8).

Referring to FIG. 2, there is disclosed a body of material, which comprises solid material 101 enclosing pores 50a, 50b, 50c, 50d having openings 102. At least some of the pores enclose at least one flake 10 of 2D material.

It is possible that the composite material 40 is intended for filtering, it is then quite likely that the porous substrate 20 is a permeable substrate comprising through pores 50. Some flakes can then be subjected to pressure differences between opposite sides of the substrate, forcing the flakes towards the permeable pores 50. In these cases, the flakes can move deep into the pores.

Furthermore, if gas is let into the container again (se FIG. 7 through FIG. 8), whereby the vacuum is removed, the flakes will have a tendency to reform again, increasing their lateral size. By doing this within the cavities of the pores, many of the flakes will get entrapped since the pores suddenly can be too narrow to allow the reformed flakes to pass through. In case of fibres/based substrates, during further liquid drain and curing, those flakes have a tendency to attach on the fibers surface, wrapping it completely.

All put together the above described technique has proven to be an easy and successful method for inserting, immobilizing and mechanically attaching 2D flake material into a porous substrate 20 creating a complex composite material 40, comprising said porous substrate and said 2D flake material.

In a second embodiment of the invention the method according to one the first or second preferred embodiment, is further characterized in the following: the substrate base being of one of the following materials: polymers (polyethylene, polypropylene, PVC, polyester or the like), inorganic (rockwool, zeolites or the like) metals (metallic sponges, metal-organic frameworks or the like), ceramics, textiles (cotton, wool, linen, artificial polymeric (organic or inorganic) fibers, including glass fibers, carbon fibers and the like). In a third preferred embodiment of the invention, a method according to one of the previous embodiment is used, and the substrate being of a porous material, having a porosity of 10-95% by area and 1-10000 openings per mm².

1. A method for inserting 2D flakes of a two dimensional material into pores of a porous substrate, comprising:
providing a porous substrate having a plurality of open pores, wherein at least some of the pores contain a gas;
applying a liquid dispersion of flexible 2D flakes of a two dimensional material to the porous substrate;
subjecting said porous substrate and said liquid dispersion to a vacuum comprising enclosing the porous substrate and the liquid dispersion in a pressure chamber, and providing the vacuum by extraction of gas from the pressure chamber, such that the gas is evacuated from the pores,
causing the liquid dispersion to be introduced into the pores, and removing the liquid from the pores, so as to leave the 2D flakes in the pores.

2. The method as claimed in claim 1, wherein applying the liquid dispersion comprises at least partially immersing the porous substrate in the liquid dispersion.

3. (canceled)

4. The method as claimed in claim 1, further comprising injecting a gas into the pressure chamber, so as to raise a pressure in the pressure chamber.

5. The method as claimed in claim 1, further comprising draining any excess liquid dispersion and/or carrier liquid from the pressure chamber.

6. The method as claimed in claim 1, wherein removing the liquid comprises subjecting the porous substrate to an elevated temperature, and/or to a reduced pressure.

7. The method as claimed in claim 1, wherein the 2D flake material comprises at least one material selected from a group consisting of G, GO, CrPS4, CrGeTe3, CrSiTe3, MnPSe3, ReSe2, Ta2NiS5, Ta2NiSe5, Bi2Se3, BN, ReS2, FeSe, GaSe, hMoS2, MoSe2, WS2, WSe2, CdPS3, HfS2, HfSe2, InSe, PtSe2, TiS3, PtS2, SnS2, TaSe2, TiS2, ZrS2, ZrSe2, MoTe2, NiS2, NiSe2, WTe2, Bi2Te3, GaTe, MnPS3, BiI3, V2O5, PdSe2, ZnPS3, MoO3, HfTe3, RuC13, SnO, P, SnSe, NiPS3, C3N4, FePS3 Ca2N, WO3, MoS2, Ge, and Si.

8. The method as claimed in claim 1, wherein the porous substrate comprises at least one material selected from a group of materials which pores are formed:
as an inherent feature of a crystalline structure;
as an inorganic gel or a ceramic;
as a textile, such as a woven, nonwoven, knitted or braided textile;
as a porous metal oxide or porous glass; or by plant or animal tissue.

9. The method as claimed in claim 7, wherein the 2D flakes comprise graphene, graphene oxide or its 2D derivatives.

10. The method as claimed in claim 1, wherein the 2D flakes presents an average thickness of 0.3-100 nm, preferably 0.3-1 nm, 1-100 nm, 1-5 nm or 1-10 nm.

11. The method as claimed in claim 1, wherein the 2D flake material is present in the dispersion in an amount corresponding to 0.01-40 g/dm3, preferably 0.01-0.1 g/dm3, 0.1-1 g/dm3, 1-10 g/dm3 or 10-40 g/dm3.

12. The method as claimed in claim 1, wherein the 2D flakes present an average flake size of 0.1-0.5 μm2 or 0.5-100 μm2, and wherein preferably 95% of the 2D flakes have flake sizes which differ less than 20% from said average flake size.

13. A porous composite material, comprising
a porous substrate comprising a solid material enclosing a plurality of open pores;
a plurality of flexible 2D flakes of a 2D material distributed within the porous substrate;
wherein at least some of the pores have an opening providing a restricted flow path into the respective pore, and
wherein the size of the 2D flakes cause them to be retained in the pores by the openings.

14. A composite material, comprising:
a substrate in the form of a textile, composed of a plurality of interlaced, and optionally bonded, fibers and/or threads,
wherein the fibers or threads are individually coated by flexible 2D material flakes, such that the flexible 2D material flakes provide a thin coating on the surface of the fiber or thread.
the coating covering the entire surface of each fiber or thread, except for such surface portions that cannot be reached by the flakes due to the fiber or thread contacting an adjacent fiber or thread.

15. The composite material as claimed in claim 14, wherein the textile is selected from a group consisting of a woven textile, a nonwoven textile, a braided textile and a knitted textile.

16. The composite material as claimed in claim 13, wherein the flexible 2D material is an electrically conducting material, such as graphene or graphene oxide.

17. The composite material as claimed in claim 14, wherein the flexible 2D material is an electrically conducting material, such as graphene or graphene oxide.
